(19) United States
(12) Patent Application Publication
(10) Pub. No.: US 2026/0327905 A1
(43) Pub. Date: Oct. 22, 2026

(54) METHOD FOR COATING A DRIED PREFORM

(71) Applicant: ALPLA Werke Alwin Lehner GmbH & Co. KG, Hard (AT)

(72) Inventors: Florian MÜLLER, Klaus (AT); Anupam AKOLKAR, Dornbirn (AT); Clemens SCHMIDT, Dornbirn (AT)

(73) Assignee: ALPLA Werke Alwin Lehner GmbH & Co. KG, Hard (AT)

(21) Appl. No.: 19/106,819

(22) PCT Filed: Aug. 28, 2023
(86) PCT No.: PCT/EP2023/073523

§ 371 Date: Feb. 26, 2025

(30) Foreign Application Priority Data
Aug. 30, 2022 (CH) 001011/2022

(51) Int. Cl. D21H 19/20; D21H 19/28; D21H 25/06; D21H 27/10

(52) U.S. Cl. CPC D21H 19/20; D21H 19/28; D21H 25/06; D21H 27/10

(57) ABSTRACT

Disclosed is a method for coating a dried preform (61) of a fiber-based product made of pulp (40), the method comprising the steps of: —providing the dried preform (61); —applying a powder coating to the inner face (63) of the dried preform (61); —hardening the powder coating by exposing same to infrared radiation (81) such that a continuous film is formed. During the irradiation procedure, the infrared radiation (81) penetrates a wall of the dried preform (61).

The present invention relates to a method for coating a dried preform of a fiber-based product made of pulp.

Different containers for holding liquid are known from the prior art. For example, glass bottles or plastic bottles for holding beverages have become established. Containers which are made of fiber-based material have likewise already been proposed.

A fiber-based container was proposed in WO 2012/139590 A1. To produce this container, what is known as pulp is introduced into a mold and within this mold pressed with a flexible balloon against a corresponding wall and compressed accordingly.

Nowadays, the still wet preform is dried at the same time or even after this compression step by applying energy, such that a dried preform is ready for further processing.

The pulp is a mixture of fibers and water, in particular natural fibers such as hemp fibers, cellulose fibers or flax fibers or a mixture thereof. The pulp may have additives, as known, for example, from PCT/EP2019/076839, which, for example, improve curing of the compressed pulp or have an influence on the later appearance or generally change the properties of the pulp or of the later container.

In the case of these containers, there is a risk of them softening due to liquid stored in the container and, for example, becoming leaky or of substances diffusing out of the container into the liquid.

It has been proposed to provide such fiber-based containers with an inner layer made of plastic, in particular to arrange within the fiber-based container a plastic bottle which can assume corresponding barrier functions. The fiber-based container thus only provides a shell for a thin-walled plastic container. Such a combination has become known from WO 2018/167192 A1.

Thus, typically a fiber-based container is provided, into which a plastic lining is introduced. This typically occurs in the following manner: in a first step, the fiber-based container is provided, and in a second step, a preform is introduced into this container. Subsequently, this preform is inflated within the fiber-based container until the preform touches an inner contour of the fiber-based container or is in contact with the inner contour of the fiber-based container. This inflation process typically takes place in a blow mold whose cavity corresponds to the outer contour of the fiber-based container. Since, in contrast to conventional blowing methods, two separate elements have to be handled, such a process is much more complicated, because the preform has to be positioned and held relative to the fiber-based container and the latter in turn has to be positioned and held within the blow mold.

An exemplary process is described, for example, in EP 3 375 593 A1. For the production of a container, EP 3 375 593 A1 describes a preform which has, in its neck region, protrusions, which can be brought into engagement with a corresponding fiber-based container, with the aim that the container and the preform remain connected to one another. However, it has been found that this type of connection is failure-prone, since the inner contour or the inner surface of the container is subject to deviations of different size, depending on the specific properties of the pulp from which the container is formed. This is disadvantageous particularly in the neck region, since for a clean pressing between the preform or its protrusions and the fiber-based container certain tolerance limits must be adhered to, but this is not always possible due to the different process parameters and due to the pulp characteristics, which vary under certain circumstances. In addition, this type of production still requires a relatively large amount of plastic.

It is an object of the invention to eliminate one or more disadvantages of the prior art. In particular, a method is to be provided which makes it possible to make a fiber-based container liquid-tight and, in particular, reduces the use of plastics.

This object is achieved by the method described in the independent claim. Further advantageous embodiments arise from the dependent claims.

A method according to the invention for coating a dried preform of a fiber-based product made of pulp, in particular a container or a fiber-based closure element for a container, comprises the steps of:
providing the dried preform,
applying a powder coating to an inner face of the dried preform,
hardening the powder coating by exposing same to infrared radiation such that a continuous film is formed.

In order to expose the powder coating to infrared radiation, the latter penetrates a wall of the dried preform during the irradiation procedure, in particular in the region of the container interior, before hitting the powder coating.

This allows the infrared source to be positioned outside the dried preform, but the powder coating can be exposed to the infrared radiation inside the dried preform.

The penetration of the dried preform makes it possible in particular to bring the powder coating to a higher temperature level than the preform.

An additional or alternative aspect of the invention also relates to a method in which the preform and the powder coating are heated, in particular differently. In this case, the powder coating is heated to a higher temperature than the preform, in particular by infrared radiation that penetrates a wall of the preform. In particular, the preform is heated substantially only via the heat radiation from the powder coating.

Preferably, the dried preform is provided with a finished opening before the powder coating is applied.

By providing a finished opening, a corresponding sealing plane or sealing surface can be provided which can interact with a corresponding closure, such as a lid. In addition, by providing a finished opening, a fibrous or inaccurate finish on the preform, for example, can be removed at the same time.

It is known that certain inaccuracies can arise during production of fiber-based containers. As a result of the material properties of the pulp, an upper, final edge of the opening is subject to greater tolerances and is often fibrous. This is disadvantageous in particular since this forms an interface to container closures and this interface must be designed to be dimensionally accurate.

Preferably, therefore, during the production of the container, the dried preform is produced in such a way that a projection is provided in the region of an opening at the top, which projection can be cut off after the preform has dried. By cutting off this projection, a correspondingly inaccurate or fibrous region of the dried preform can be removed.

It may be provided that the powder coating is additionally applied to the finished opening in the dried preform. This also allows the finished opening to be sealed.

In addition, a powder coating can be applied to an outer face of a neck region of the dried preform after finishing. The dried preform remains uncoated on its outer face at least in regions.

By coating the outer face of the neck region, the latter can also be sealed and/or made more durable during use.

The uncoated region on the outer face of the preform allows the product to be recycled. The uncoated region provides a contact surface where the product can be broken open or softened by the use of water. The product can therefore be recycled more easily.

A meltable polymer can be applied as a powder coating. Polymers have advantageous properties and are easy to process.

Preferably, the meltable polymer used is a polyester such as polyethylene terephthalate (PET), polyethylene furanoate (PEF), polyethylene isosorbide terephthalate (PEIT), polylactide (PLA), polybutylene succinate (PBS), poly-ε-caprolactone (PCL) or polyhydroxyalkanoate (PHA), in particular polyhydroxybutyrate (PHB). These polyesters are preferably bio-based. Ethylene-vinyl alcohol copolymer (EVOH) has also proven to be suitable.

The powder coating can be electrostatically charged for application. In particular, it can be provided that a conductive mold which encases the dried preform is charged with opposite polarity with respect to the powder. The powder then settles in particular on the inner face of the preform and remains there.

An infrared source for generating the infrared radiation is preferably arranged outside the dried preform.

This makes it possible to direct the infrared radiation in a targeted manner, at a specific distance and at a specific angle, onto the dried preform and, in particular, onto the powder coating at a corresponding distance and angle. Infrared radiation has a wavelength of 780 nm to 1400 nm in the near-infrared range, a wavelength of 1.4 μm to 3.0 μm in the short-wave infrared range, a wavelength of 3.0 to 8.0 μm in the mid range, a wavelength of 8.0 μm to 15 μm in the long-wave range and a wavelength of 15 μm to 1 mm in the far range.

The wavelength of the present infrared radiation is preferably between 1 μm and 10 μm, in particular between 2 μm and 7 μm. These wavelengths can be easily absorbed by polymers. The absorption capacity is particularly high in the short-wave range, preferably in the range from 2 μm to 7 μm.

Preferably, the proportion of higher wavelength radiation, i.e. radiation in the far range, is less than 70%, in particular less than 50%, preferably less than 30%.

This ensures that the fiber-based preform is subjected to as little thermal stress as possible.

These in turn are wavelength ranges that are not or only slightly absorbed by the wall of the dried preform. In other words, these wavelengths make it possible to melt the powder coating without unnecessarily radiating energy into the dried preform.

To be exposed to the infrared radiation, the dried preform can be conveyed through a furnace. The present furnace is a device within which a plurality of infrared sources are arranged. These can, for example, be arranged along a congruent contour of the dried preform and at a distance therefrom.

The emitted infrared radiation is preferably infrared radiation generated without a heat source. This makes it possible to reduce the effect on the fiber-based preform itself.

Provision can also be made to install reflectors in the furnace that redirect and/or reflect the emitted infrared radiation.

Provision can also be made to arrange different infrared sources along the length of the furnace. For example, infrared sources that emit radiation with a wavelength of 6 μm can be arranged at the entrance to the furnace to heat up the powder coating quickly. Infrared sources emitting radiation with a wavelength of 3 μm can be arranged downstream to keep the melting rate constant.

During exposure to infrared radiation, the dried preform can be rotated around its longitudinal axis. The dried preform is therefore moved linearly through the furnace while rotating around its longitudinal axis. Accordingly, each region of a surface of the preform is guided past corresponding infrared sources, such that the dried preform and thus the powder coating are evenly exposed to infrared radiation from all sides.

To prevent the dried preform from overheating, provision can be made to cool it by means of a cooling air stream during exposure to the infrared radiation. Overheating of the dried preform is avoided. Overheating of the dried preform would cause the fibers to degenerate and the strength to decrease.

The infrared sources can, for example, be arranged at different heights along the conveying direction of the preform, such that they each act on different regions of the preform.

Alternatively or additionally, provision can be made to provide infrared sources with different powers or to control the infrared sources, for example based on a respective product profile, such that their power is adjusted depending on the product or the dwell time of the product.

Preferably, the dried preform is transparent in the wave range from 1 μm to 10 μm. This can be achieved by ensuring that the chemical composition of the preform has functional groups that cannot be excited in this particular wave range.

Due to the transparency in this wavelength range, the corresponding infrared radiation can penetrate a wall of the dried preform without heating the preform up unnecessarily.

Accordingly, the powder coating preferably absorbs infrared radiation in the wavelength range from 1 μm to 10 μm. This means that the coating can be heated up quickly.

Energy is thus applied to the applied powder coating and the powder is converted into a melt. The melting process forms a homogeneous film that provides an appropriate seal. Preferably, this film extends from the inner face over the finished opening to an outer region of the neck and forms a continuous seal in this region.

It may be provided that the dried preform is tested for leaks. This can prevent defective products from being sold.

After sealing, i.e. after melting of the powder coating and subsequent cooling, a product can be poured into the dried preform, provided that the dried preform is designed as a container. The dried preform can then be closed with a closure. Accordingly, a closed body is created for the transport and protection of liquid products. In particular, by sealing the edge of the packaging, a reliable seal can be created in this region with, for example, a corresponding sealing cone or a sealing plane, for example made of a sealing material such as a liner.

The method according to the invention is explained below with reference to schematic figures. In the figures:

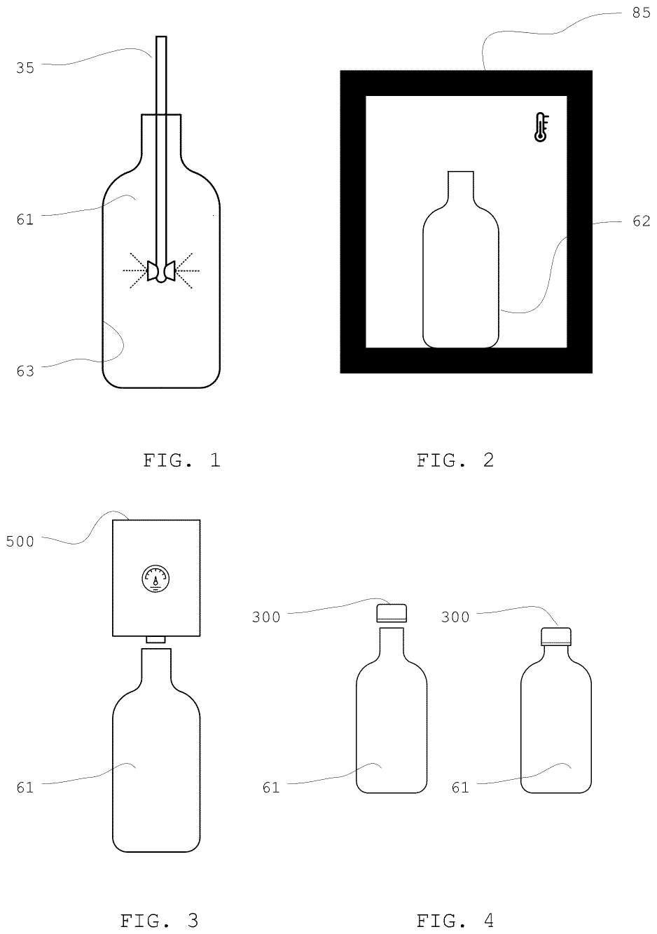

FIG. 1: shows a powder coating process;

FIG. 2: shows the drying step of the powder coating process;

FIG. 3: shows a leak test;

FIG. 4: shows the closure process;

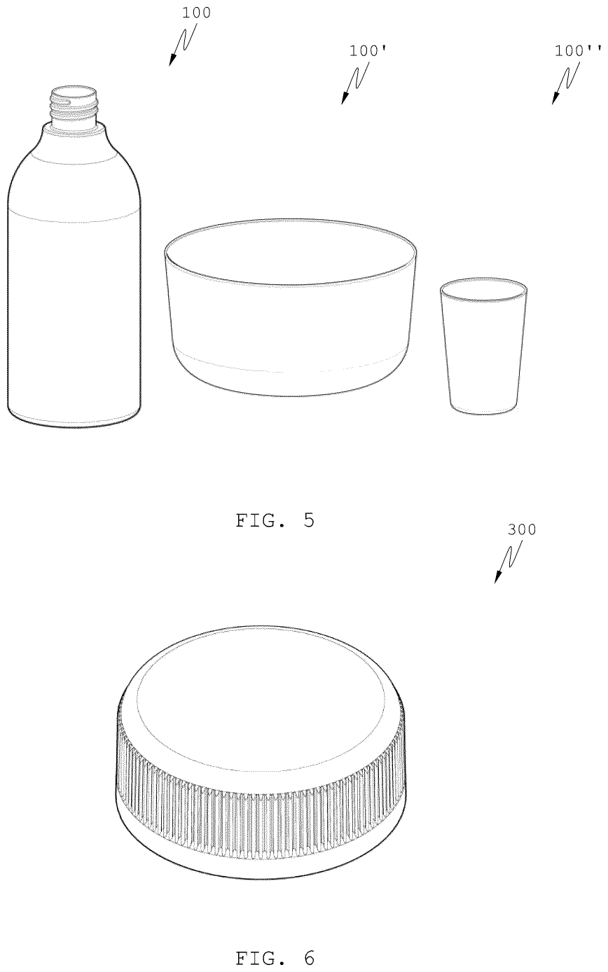

FIG. 5: shows, by way of example, further typical products which can be produced by means of the method according to the invention;

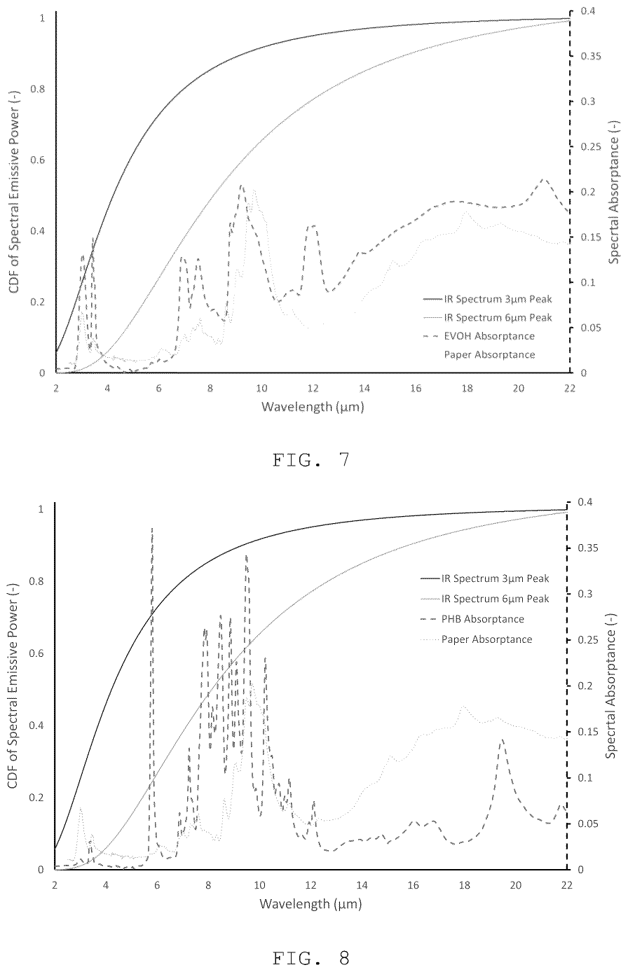

FIG. 6: shows an example of a typical fiber-based closure that can be produced by means of the method according to the invention;

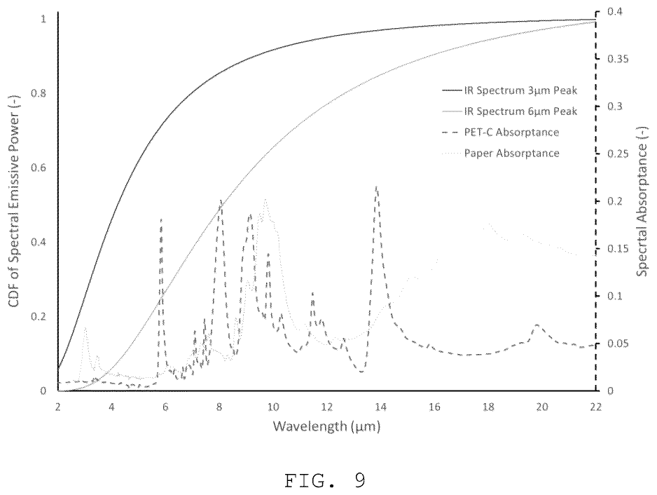

FIG. 7: shows a representation of first absorption spectra;

FIG. 8: shows a representation of second absorption spectra;

FIG. 9: shows a representation of third absorption spectra.

FIG. 1 shows a coating step. A dried and already finished preform 61 is fed to a powder coating system not shown in detail here. In the following step, an electrostatically charged lance 35 is inserted into the finished preform 61. The latter is located in an oppositely charged casing which is also not shown here. The electrostatic charge of the applied powder causes it to adhere to the inner face 63 of the finished preform 61.

The now coated finished preform 61 is transferred into a furnace and exposed to infrared radiation, as shown in FIG. 2. This causes the powder coating to melt, creating a continuous, homogeneous film. The preform 61 is thus sealed.

The preform 61 can then be tested for leaks using a corresponding testing device 500, as shown in FIG. 3.

The preform 61 can then be closed with a lid 300, as shown in FIG. 4.

FIG. 5 shows examples of other typical fiber-based products that can be produced using the method described herein. For example, a container 100 is shown in the shape of a bottle. This also has a thread on the bottle neck and substantially corresponds to a fiber-based product made from a preform 61 as shown in FIGS. 1 to 4. The container 100′ is in the shape of a bowl; the container 100″ is in the shape of a cup.

FIG. 6 shows an example of a typical fiber-based closure 300 that can be produced using the method described herein.

FIGS. 7 to 9 each show different comparisons of different absorption spectra of different materials.

In FIGS. 7 to 9, the dark solid line shows the emitted infrared power as a cumulative distribution function of an infrared source with a 3 μm peak and the light solid line shows the emitted infrared power as a cumulative distribution function of an infrared source with a 6 μm peak.

FIGS. 7 to 9 also show the absorptance and absorption spectrum of the dried preform. The corresponding line is shown as a fine dotted line. It can be seen that the preform has increased absorption in the range around approximately 10 μm and from the range from around 14 μm.

In FIG. 7, the dashed line shows the absorptance and absorption spectrum of a powder coating made of EVOH. As can be seen, EVOH has increased absorption in the range around 3 μm, around 3.5 μm and in the range between 7 μm and 8 μm. It is therefore clear that radiation with these wavelengths is absorbed much better by EVOH than by the preform. The powder coating is therefore heated up more quickly, until it melts, without the preform being heated up as much.

In FIG. 8, the dashed line shows the absorptance and absorption spectrum of a powder coating made of PHB. As can be seen, PHB has increased absorption in the range around 6 μm and in the range between 8 μm and 10 μm. It is therefore clear that radiation with these wavelengths is absorbed much better by PBH than by the preform. The powder coating is therefore heated up more quickly, until it melts, without the preform being heated up as much.

In FIG. 9, the dashed line shows the absorptance and absorption spectrum of a powder coating made of PET-C, i.e. crystalline PET. As can be seen, PET-C has an increased absorption in the range around 6 μm and around 8 μm. It is therefore clear that radiation with these wavelengths is absorbed much better by PET-C than by the preform. The powder coating is therefore heated up more quickly, until it melts, without the preform being heated up as much.

1. A method for coating a dried preform (61) of a fiber-based product made of pulp (40), in particular a container (100, 100′, 100″) or a fiber-based closure element (300) for a container (100, 100′, 100″), comprising the steps of
providing the dried preform (61),
applying a powder coating to an inner face (63) of the dried preform (61)
hardening the powder coating by exposing same to infrared radiation (81) such that a continuous film is formed,
wherein
the infrared radiation (81) penetrates a wall of the dried preform (61) during the irradiation procedure.

2. The method according to claim 1, wherein the dried preform (61) is provided with a finished opening before the powder coating is applied.

3. The method according to claim 3, wherein the powder coating is additionally applied to the finished opening in the dried preform (61).

4. The method according to claim 2, wherein a powder coating is additionally applied to an outer face (64) of a neck region of the dried preform (61) after finishing, wherein the dried preform (61) remains uncoated on its outer face at least in regions.

5. The method according to claim 1, wherein a meltable polymer is applied as a powder coating, in particular polyester such as polyethylene terephthalate (PET), polyethylene furanoate (PEF), polyethylene isosorbide terephthalate (PEIT), polylactide (PLA), polybutylene succinate (PBS), poly-ε-caprolactone (PCL) or polyhydroxyalkanoate (PHA), in particular polyhydroxybutyrate (PHB), wherein these polyesters are preferably bio-based, or ethylene-vinyl alcohol copolymer (EVOH).

6. The method according to claim 1, wherein the powder coating is electrostatically charged for application.

7. The method according to claim 1, wherein an infrared source (80) for generating the infrared radiation (81) is arranged outside the dried preform (61).

8. The method according to claim 1, wherein the wavelength of the infrared radiation (81) is between 1 μm and 10 μm, preferably between 2 μm and 7 μm.

9. The method according to claim 1, wherein the dried preform (61) is conveyed through a furnace (85) for exposure to the infrared radiation (81).

10. The method according to claim 1, wherein the dried preform (61) is rotated about its longitudinal axis during exposure to the infrared radiation (81).

11. The method according to claim 1, wherein the dried preform (61) is cooled by a cooling air stream during exposure to the infrared radiation (81).

12. The method according to claim 1, wherein the dried preform (61) is transparent in a wavelength range from 1 μm to 10 μm.

13. The method according to claim 1, wherein the powder coating absorbs the infrared radiation (81) in a wavelength range from 1 μm to 10 μm.

14. The method according to claim 1, wherein the dried preform (61) is tested for leaks.

15. The method according to claim 1, wherein the dried preform (61) is a container (100), wherein a product is poured into the dried preform (61) and the dried preform is subsequently closed with a closure.
